(19) United States
(12) Patent Application Publication
(10) Pub. No.: US 2009/0038670 A1
(43) Pub. Date: Feb. 12, 2009

(54) Pet collar with solar powered global positioning system device

(76) Inventor: Chia-Lung Shu, Hsinchuang City (TW)

Correspondence Address: Joe McKinney Muncy, PO Box 1364, Fairfax, VA, 22038-1364, US

(21) Appl. No.: 11/882,846

(22) Filed: Aug. 6, 2007

(51) Int. Cl. A01K 27/00; G01S 1/00; H01L 31/042

(52) U.S. Cl. 136/244; 119/859; 342/357.06

(57) ABSTRACT

A pet collar with a solar powered global positioning system (GPS) device in accordance with the present invention has a band, a GPS device and multiple solar panels. The band is annular and has an outer surface. The GPS device is mounted on the outer surface of the band and has a GPS module and a rechargeable battery module. The solar panels are mounted on the outer surface of the band, are electronically connected to the GPS device with wires, absorb and convert solar energy into electric power to provide power to the GPS module and charge the rechargeable battery module. Therefore, the solar powered GPS device mounted on such a pet collar is reliable and requires no battery maintenance.

### BACKGROUND OF THE INVENTION

1. Field of the Invention

The present invention relates to a pet collar, and more particularly to a pet collar having a solar powered global positioning system device.

2. Description of Related Art

Many people are owners of pets including dogs or cats. However, pets may run away or be stolen to the owner's distress.

Therefore, the owner puts a collar on their pets' neck which has a tag mounted on the pet collar to record the owner's contact information. If the pet becomes lost, the owner can be contacted using this information. However, the owner cannot actively locate their pet with this help.

Therefore, a global positioning system (GPS) device can be mounted on the pet collar to allow the owner to find the pet. However, the GPS device requires batteries that require frequent checking and replacement.

To overcome the shortcomings, the present invention provides a pet collar with a solar powered GPS device to mitigate or obviate the aforementioned problems.

### SUMMARY OF THE INVENTION

The main objective of the invention is to provide a pet collar with a solar powered global positioning system (GPS) device that is reliable and requires little maintenance.

A pet collar in accordance with the present invention comprises a band, a GPS device and multiple solar panels. The band is annular and has an outer surface. The GPS device is mounted on the outer surface of the band and has a GPS module and a rechargeable battery module. The solar panels are mounted on the outer surface of the band, are electronically connected to the GPS device with wires, absorb and convert solar energy into electric power to provide power to the GPS module and charge the rechargeable battery module. Therefore, the solar powered GPS device is reliable and requires little maintenance.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a pet collar in accordance with the present invention with a global positioning system (GPS) shown in dotted lines;

FIG. 2 is a top view of the pet collar in FIG. 1 with the GPS module shown in dotted lines;

FIG. 3 is an enlarged perspective view of the pet collar in FIG. 1;

FIG. 4 is a top view of a second embodiment of a pet collar in accordance with the present invention with a GPS module shown in dotted lines; and

FIG. 5 is an enlarged, partially exploded perspective view of a third embodiment of a pet collar in accordance with the present invention.

### DETAILED DESCRIPTION OF PREFERRED EMBODIMENT

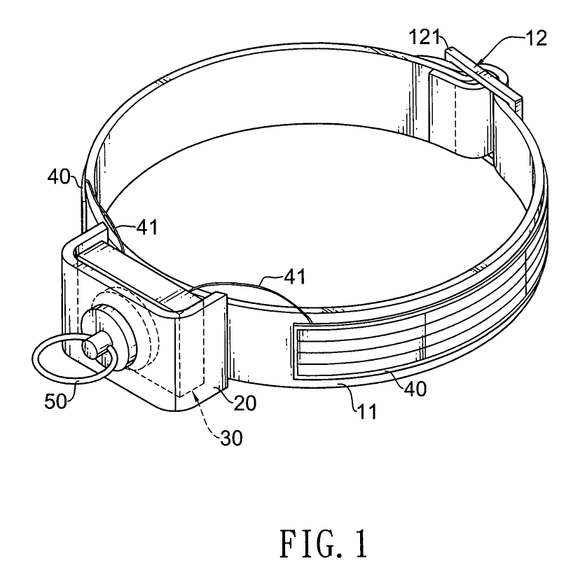

With reference to FIG. 1, a pet collar in accordance with the present invention comprises a band (11), an optional shell (20), a global positioning system (GPS) device (30), multiple solar panels (40) and an optional ring (50).

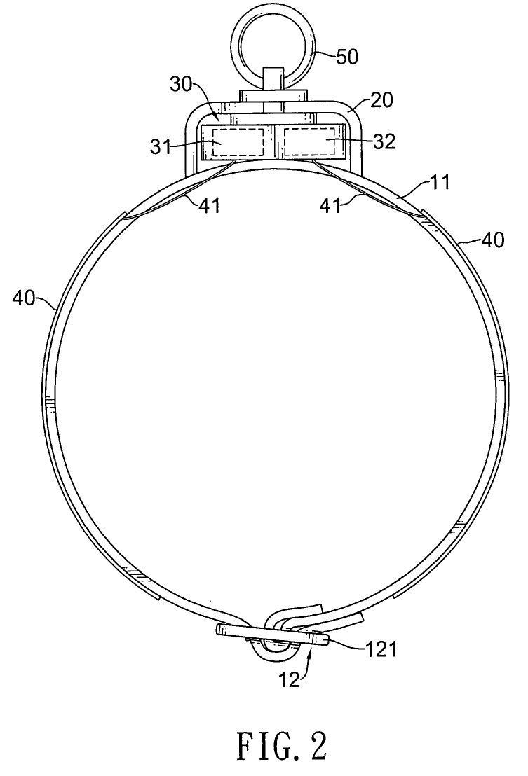

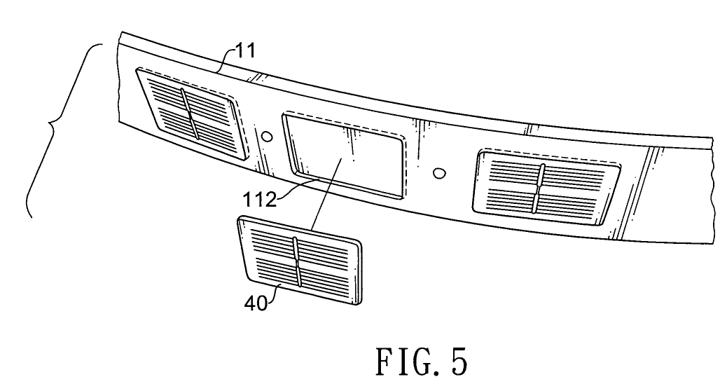

With further reference to FIGS. 2 and 5, the band (11) is annular and has an outer surface, an optional fastener (12) and may have multiple panel recesses (112). The band (11) may have two ends and multiple through holes (111). The through holes (111) are formed near one end of the band (11). The fastener (12) is used to link the two ends of the band (11) and may be a buckle (121). The buckle (121) is mounted on the end without through holes (111) and is fastened using at least one of the through holes (111). The panel recesses (112) are formed on the outer surface of the band (11).

The shell (20) is mounted on the outer surface of the band (11), forms a shell chamber between the band (11) and the shell (20) and has an outer surface. Furthermore, the shell (20) may be riveted onto the band (11).

The GPS device (30) is mounted on the outer surface of the band (11) and may be in the shell chamber to prevent the GPS device (30) from impacts. The GPS device (30) comprises a GPS module (31) and a rechargeable battery module (32).

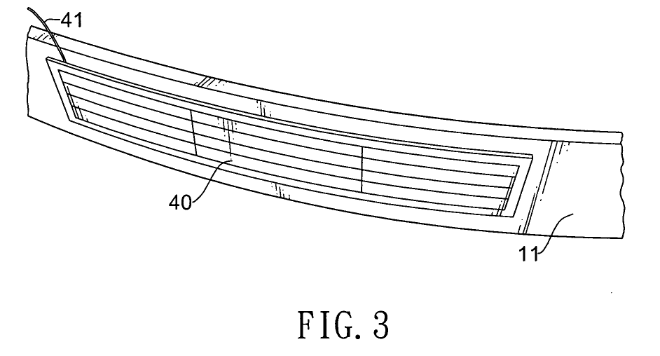

With further reference to FIG. 3, the solar panels (40) are mounted on the outer surface of the band (11), are electronically connected to the GPS device (30) with wires (41) and being able to absorb and convert solar energy into electric power to provide power to the GPS module (31) and charge the rechargeable battery module (32). The solar panels (40) may protrude from the outer surface of the band (11) or mounted flush with the band (11) in the panel recesses (112).

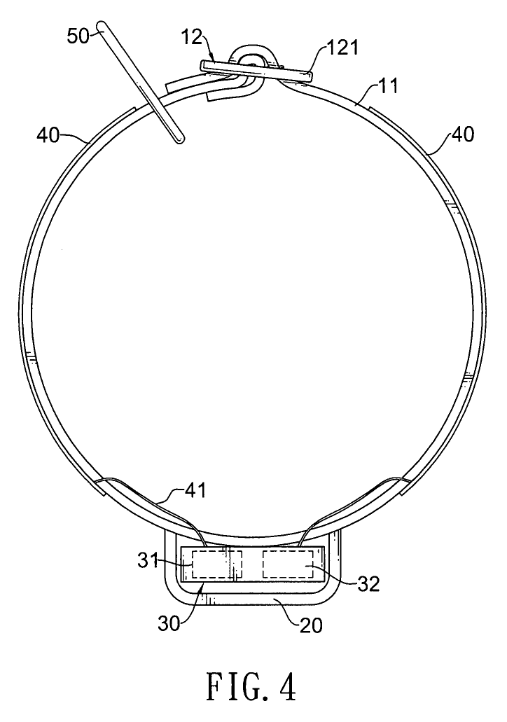

With further reference to FIG. 4, the ring (50) may be mounted on the outer surface of the shell (20) or slidably around the band (11). The ring (50) allows a rope or a tag to be attached to the band (11).

The GPS module (31) can receive electric power from the rechargeable battery module (32) or the solar panels (40). Furthermore, the solar panels (40) also charge the rechargeable battery module (32). Therefore, the solar panels (40) provide electric power to the GPS module (31) in the daytime and the rechargeable battery module (32) provides electric power to the GPS module (31) when no solar energy is available. Accordingly, the GPS device (30) works reliable and requires no battery maintenance.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A pet collar with a solar powered global positioning system (GPS) device comprising:
a band being annular and having an outer surface;
a GPS device mounted on the outer surface of the band and comprises a GPS module and a rechargeable battery module; and
multiple solar panels being mounted on the outer surface of the band, being electronically connected to the GPS device with wires and being capable of absorbing and converting solar energy into electric power to provide electric power to the GPS module and charge the rechargeable battery module.

2. The pet collar as claimed in claim 1 further comprising
a shell mounted on the outer surface of the band, forming a shell chamber between the band and the shell and having an outer surface, and the GPS device being mounted in the shell chamber to prevent the GPS device from impacts.

3. The pet collar as claimed in claim 1 further comprising a ring being mounted slidably around the band to be allowed moving around the band.

4. The pet collar as claimed in claim 2 further comprising a ring mounted on the outer surface of the shell.

5. The pet collar as claimed in claim 1, wherein
the band has multiple panel recesses formed on the outer surface of the band; and
the solar panels are mounted flush with the band in the panel recesses.

6. The pet collar as claimed in claim 2, wherein
the band has multiple panel recesses formed on the outer surface of the band; and
the solar panels are mounted flush with the band in the panel recesses.

7. The pet collar as claimed in claim 3, wherein
the band has multiple panel recesses formed on the outer surface of the band; and
the solar panels are mounted flush with the band in the panel recesses.

8. The pet collar as claimed in claim 4, wherein
the band has multiple panel recesses formed on the outer surface of the band; and
the solar panels are mounted flush with the band in the panel recesses.

9. The pet collar as claimed in claim 1, wherein the solar panels protrude from the outer surface of the band.

10. The pet collar as claimed in claim 2, wherein the solar panels protrude from the outer surface of the band.

11. The pet collar as claimed in claim 3, wherein the solar panels protrude from the outer surface of the band.

12. The pet collar as claimed in claim 4, wherein the solar panels protrude from the outer surface of the band.

13. The pet collar as claimed in claim 1, wherein the band further comprises
two ends; and
a fastener used to link the two ends of the band.

14. The pet collar as claimed in claim 2, wherein the band further comprises
two ends; and
a fastener used to link the two ends of the band.

15. The pet collar as claimed in claim 3, wherein the band further comprises
two ends; and
a fastener used to link the two ends of the band.

16. The pet collar as claimed in claim 4, wherein the band further comprises
two ends; and
a fastener used to link the two ends of the band.

17. The pet collar as claimed in claim 13, wherein
the band further has multiple through holes formed through the band near one end of the band; and
the fastener is a buckle mounted on the end without the through holes and being fastened using at least one of the through holes.

18. The pet collar as claimed in claim 14, wherein
the band further has multiple through holes formed through the band near one end of the band; and
the fastener is a buckle mounted on the end without the through holes and being fastened using at least one of the through holes.

19. The pet collar as claimed in claim 15, wherein
the band further has multiple through holes formed through the band near one end of the band; and
the fastener is a buckle mounted on the end without the through holes and being fastened using at least one of the through holes.

20. The pet collar as claimed in claim 16, wherein
the band further has multiple through holes formed through the band near one end of the band; and
the fastener is a buckle mounted on the end without the through holes and being fastened using at least one of the through holes.
